(19) United States
(12) Patent Application Publication
(10) Pub. No.: US 2026/0089083 A1
(43) Pub. Date: Mar. 26, 2026

(54) PREDICTING LOCATION OF LINES IN HIGHLY DISTRIBUTED SYSTEM

(71) Applicant: International Business Machines Corporation, Armonk, NY (US)

(72) Inventors: Vesselina Papazova, Highland, NY (US); Matthias Klein, Poughkeepsie, NY (US); Robert J. Sonnelitter, III, Bedford Hills, NY (US); Ekaterina M. Ambroladze, Somers, NY (US)

(21) Appl. No.: 18/896,208

(22) Filed: Sep. 25, 2024

(51) Int. Cl. H04L 45/12; H04L 45/302

(52) U.S. Cl. CPC H04L 45/12; H04L 45/302

(57) ABSTRACT

A system may execute an adaptive algorithm for a distributed system, wherein the adaptive algorithm comprises a predictor using line location of preceding stores in a first stream and routing data preemptively towards the line location; identify, through a mechanism, a stream of stores targeting an identified chip in the distributed system; and apply the adaptive algorithm in the system.

### BACKGROUND

Aspects of the present disclosure relate to store streams in distributed system.

In a highly distributed system, when a requesting chip (or node) in the system seeks data, it typically sends a request through the network. In a distributed system, data may be stored across multiple nodes, each holding parts of the overall dataset (often using techniques like sharding or replication). The system uses a distributed lookup mechanism (e.g., distributed hash tables or consistent hashing) to identify where the data resides.

### SUMMARY

Aspects of the present disclosure relate to a computer program product, system, and method for predicting location of lines in a highly distributed system. In some embodiments, the computer program product, the system, and the method may execute an adaptive algorithm for a distributed system, wherein the adaptive algorithm comprises a predictor using line location of preceding stores in a first stream and routing data preemptively towards the line location; identify, through a mechanism, a stream of stores targeting an identified chip in the distributed system; and apply the adaptive algorithm in the system.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 illustrates an example computing environment, according to various embodiments of the present disclosure.

FIG. 2A depicts an illustrative requesting drawer address broadcast flow, according to various embodiments of the present disclosure.

FIG. 2B depicts an illustrative flow to indicate the current state of the chip shown, according to various embodiments of the present disclosure.

FIG. 2C depicts an illustrative sending the combined response to all the chips, according to various embodiments of the present disclosure.

FIG. 2D depicts an illustrative a forwarding of the Reset/Final Response from non-participating chips which may be send any time after the observed the Combined Response, according to various embodiments of the present disclosure.

FIG. 2E depicts an example of the data transfer from requesting chip to the chip where the store will be performed, according to various embodiments of the present disclosure.

FIG. 2F depicts an illustration of returning the End of Coherency Response to the chip where the store may be performed, according to various embodiments of the present disclosure.

FIG. 2G depicts an illustration of the storing chip returning to requesting chip a notification that the data has been successfully stored, according to various embodiments of the present disclosure.

FIG. 3A depicts an illustration of broadcasting a signal for each drawer to look for the line, according to various embodiments of the present disclosure.

FIG. 3B depicts an illustration of sending for a response to the requesting chip, according to various embodiments of the present disclosure.

FIG. 3C depicts an illustrates sending the drawer scope combined response to participating chips, according to various embodiments of the present disclosure.

FIG. 3D depicts an illustration of all participating chips receiving a global combined response from the requesting chip, according to various embodiments of the present disclosure.

FIG. 3E depicts an illustration of how the data for the operation may be routed, according to various embodiments of the present disclosure.

FIG. 3F depicts an illustration of the end of coherency response (ERESP) flow, according to various embodiments of the present disclosure.

FIG. 3G depicts an illustration of the distribution of the Reset/sponse/Final Response (RRESP/FRESP), according to various embodiments of the present disclosure.

FIG. 4 depicts an illustrative method 400 for prediction location of lines in a distributed system, according to various embodiments of the present disclosure.

FIG. 5 depicts an illustrative table of data that is used to determine store stream identification (ID), according to various embodiments of the present disclosure.

FIG. 6 depicts an illustrative table of data used in the process of predicting a storage location, according to various embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure relate predicting location of lines in a highly distributed system. While the present disclosure is not necessarily limited to such applications, various aspects of the disclosure may be appreciated through a discussion of various examples using this context.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as block 107 (e.g., code to enact method 400). In addition to block 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 (including user interface (UI), device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

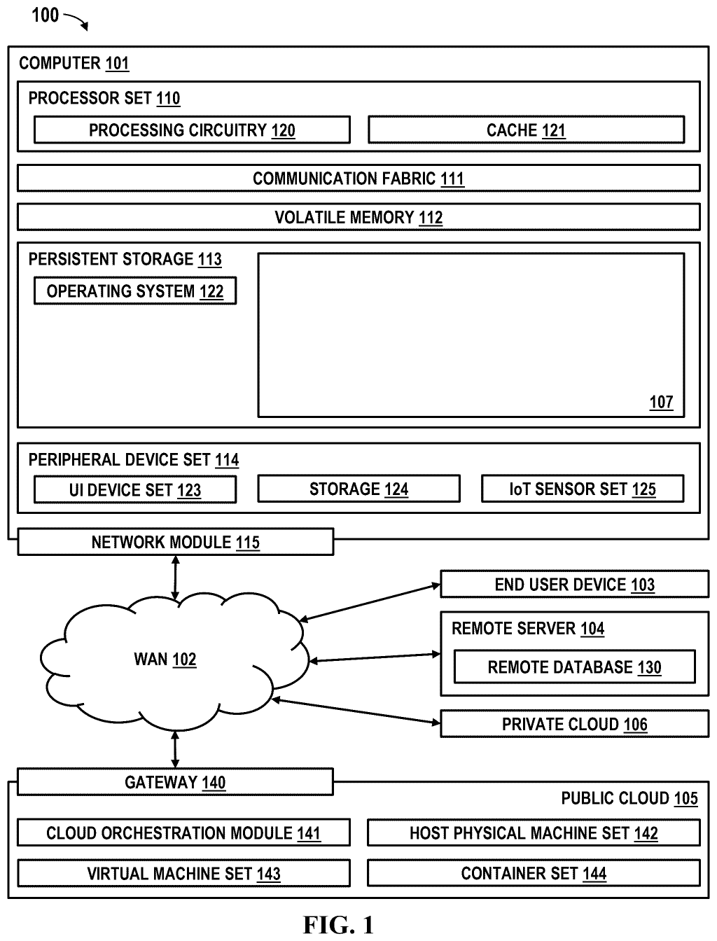

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 107 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 107 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some instances, a highly distributed system is a network of interconnected computers, or nodes, that collaborate to perform computing tasks, data storage, and processing across multiple locations. In some instances, highly distributed systems are decentralized, meaning no single node controls the system; instead, each node operates independently while contributing to the overall function. In some instances, highly distributed systems are designed for scalability, highly distributed systems can easily expand or contract by adding or removing nodes to handle varying workloads. They are also built for fault tolerance, with redundant nodes and data replication ensuring that the system continues functioning even when individual components fail. These systems allow for concurrent operations, meaning multiple tasks can be processed simultaneously across different nodes, enhancing efficiency. In some instances, in highly distributed systems, data is distributed or replicated across nodes to ensure quick access and minimize latency. In some instances, the nodes in a highly distributed system may be geographically spread out, improving performance for users in different regions and reducing the dependency on any single data center. In some instances, highly distributed systems are commonly used in cloud computing platforms, content delivery networks (CDNs), and peer-to-peer networks to handle large-scale storage, real-time data processing, and global services.

In some instances, a stream of stores refers to a sequence of write operations or store operations in a system, where data is continuously written to memory or storage locations. In the context of computing or distributed systems, it involves sending or committing data to various storage units or memory addresses over time as part of a process or transaction. In some instances, a stream of stores may be continuously storing data across a distributed network of nodes, particularly in real-time applications like log aggregation, sensor data collection, or event streaming.

In a distributed system, for stream of stores the location of the lines is usually the same for the entire stream. In some embodiments, a line herein refers to a data line such as flow of data between different nodes, drawers, services, or components. The line represents how data moves through a system, from input to processing, storage, and output. In many cases, the stream of stores targeting the same chip is associated with store originating from the same input output (IO) channel. In other cases, a specific thread of operation can drive stream of stores targeting the same location. This information can be used to assign a unique stream identification (ID) to the stream of stores, which may also be referred to herein simply as stores.

In some instances, when a system has different IO channels attached to the system, the system may have stores coming in from a particular IO channel the majority of time. In some instances, the system may normally target the same chip with the stores. Thus, in some instances, the stores that tend to target the same location including situations where there are different channels connected to the same chip. Thus, there is a need to predict where data will be stored for a specific line (e.g., stream). Therefore, a method and system architecture are proposed to use a main memory location to speculatively route the store data for initial stores in the store stream and then switching to using the line location of preceding stores in the store stream. In cases of highly distributed system, where the data need to pass though intermediate chips with resources assigned as the operation progresses from one scope to another to get to destination, the predictor can be used to route data to the first intermediate chip towards predicted location and forwarded to the next chip once a resource becomes available. In some embodiments, the system also monitors the success rate. In some embodiments, the proposed prediction mechanism may be applied to different type of protocols like including a multi scope protocol that has different levels where coherency may be established to ensure the data store works in the environment. In some embodiments, the system may keep track of previous stores where the data is actually found for the line, and the method may be iteratively improved for future stores.

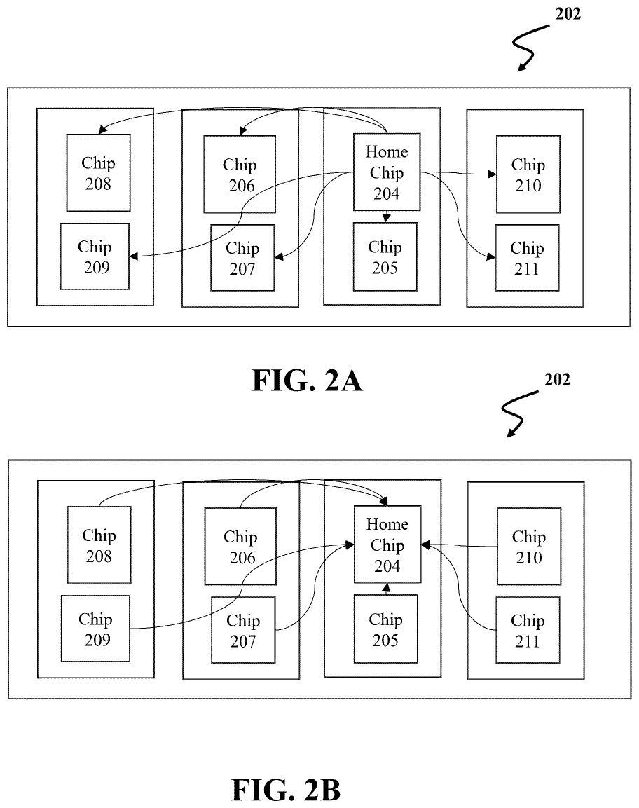

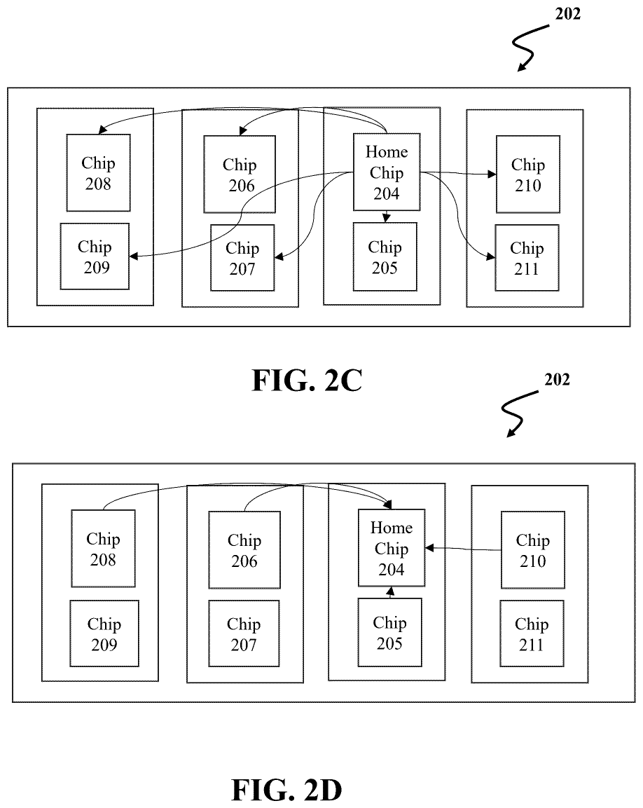

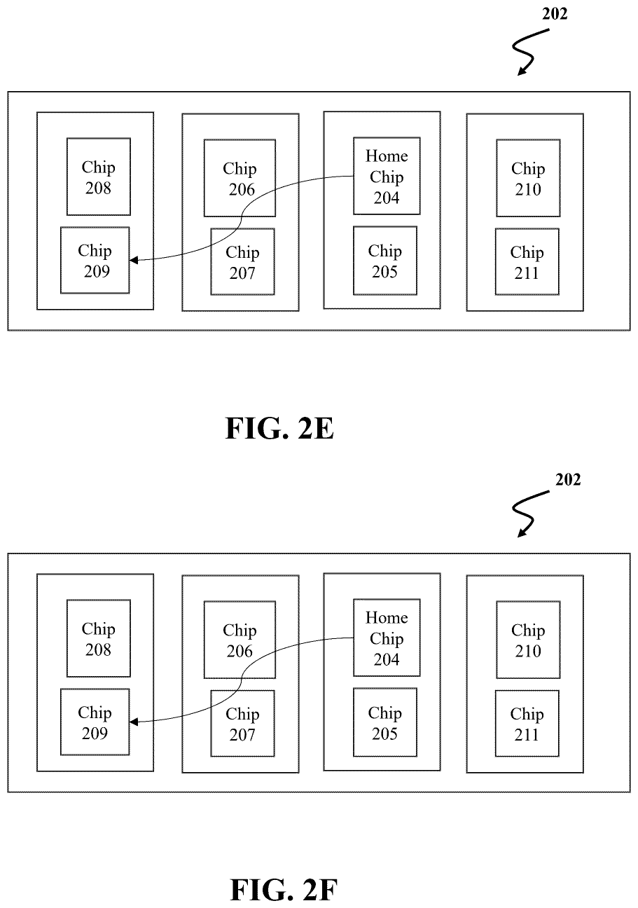

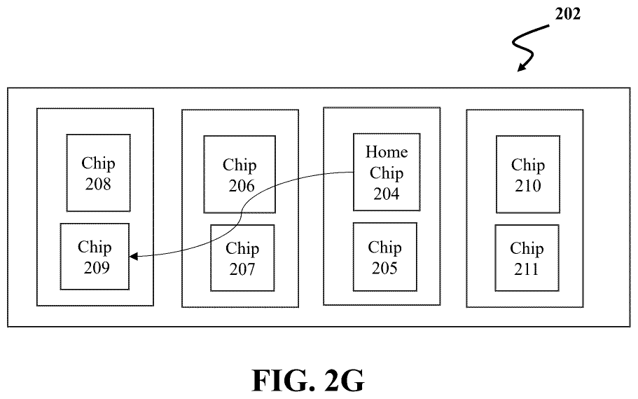

FIGS. 2A-2F set forth an illustrative process flow for a multi scope protocol in a distributed system including an example requesting drawer 202. The illustrated system is shown with a particular configuration for explanation purposes, but other configuration and system types may be used, as will be understood by one skilled in the art. In some embodiments, the requesting drawer 202 includes requesting chip 204. In some embodiments, a drawer is a collection of processing units (e.g., processors, central processing complexes, computing system 100, and/or one or more components in processing system 100) and contain other computer components (as described in FIG. 1). In some instances, a drawer in a distributed system typically consists of multiple nodes, each containing Single Chip Modules (SCMs) for processing and memory control. Each node houses several Processor SCMs (PU SCMs), which include multiple processor cores that operate in parallel, often in a symmetric multiprocessing (SMP) configuration. In some instances, the cores may be supported by a hierarchy of caches, for example Level 1 (L1) for rapid access to instructions and data, followed by larger Level 2 (L2), Level 3 (L3), and sometimes Level 4 (L4) caches, which improve performance by reducing memory access times. In some instances, each drawer may also contain storage control SCMs (SC SCMs) responsible for managing memory access and control, often integrating a higher-level cache for staged memory transfers. In some instances, memory modules, such as DIMMs, are distributed across the drawer, providing the system with the required memory capacity.

Power distribution units and cooling systems are integrated into the drawer to ensure operational stability, with redundant power supplies to maintain functionality during failures.

In some embodiments, the requesting drawer 202 also includes other chips 205, 206, 207, 208, 209, 210, and 211 (e.g., other processors). In some instances, other drawers may be operatively coupled to the requesting drawer via buses (not depicted), such as an A-bus. Each chip on the requesting drawer 202 (e.g., chips 204, 205, 206, 207, 208, 209, 210, and 211) are operatively coupled to every other chip on the drawer via a direct bus (not depicted), hereinafter referred to as an “X-bus.”

FIG. 2A depicts an illustrative requesting drawer address broadcast flow. Drawer 202 has multiple chips (e.g., chips 204, 205, 206, 207, 208, 209, 210, and 211). In some embodiments, the chips in drawer 202 are searched to see if the line is on drawer 202. In some embodiments, a line herein refers to a data line such as flow of data between different nodes, drawers, services, or components. The line represents how data moves through a system, from input to processing, storage, and output. If the line is not on drawer 202 the system may move onto the next drawer and repeat the search. The line on that drawer and the system may have to broadcast the drawer and move on to the next code which is the system code. In some instances, the system may search the caches on the other drawers (not depicted) in the system until the line is found.

In some embodiments, the protocol for determining if the line is in the draw is to broadcast for the scope of the line from the requesting chip 204 (see arrows in FIG. 2A).

Each chip within the scope returns a partial response (PRESP) flow to indicate the current state of the chip shown by the arrows in FIG. 2B. The system may use all those partial responses to generate a combined response. In some embodiments, requesting chip 204 may send (depicted by the arrows in FIG. 2C) the combined response to all the chips (e.g., chips 205, 206, 207, 208, 209, 210, and/or 211) in drawer 202 that are participating.

FIG. 2D depicts a forwarding of the Reset/Final Response from non-participating chips which may be send any time after the observed the Combined Response. In some embodiments, some chips within the requesting drawer act as pass-through chips (e.g., chip 208, 206, and 210) in case the operation needs to be forwarded to the other drawers. In some embodiments, the pass through chips need to observe the combined response before they can complete the operation. In some embodiments, once it is determined that no off-drawer broadcast is needed those chips can send Reset/Final response.

In some embodiments, upon a determination that the system has the capacity to perform the store in drawer 202, the operation may route the data to drawer 202 the system may finish the operation by storing the data in drawer 202. In some instances, FIG. 2E represents the data transfer from requesting chip to chip 209 where the store will be performed. FIG. 2F represents, returning the End of Coherency Response to the chip where the store may be performed and push the Reset/Final Response from the storing chip.

FIG. 2G depicts chip 209 returning to requesting chip 204 a notification that the data has been successfully stored.

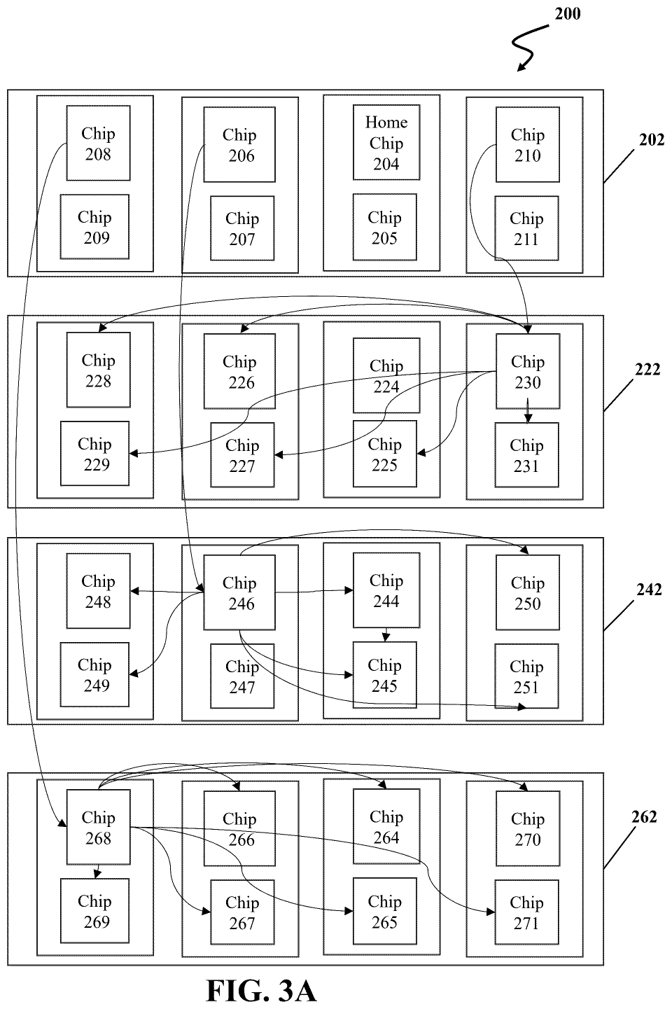

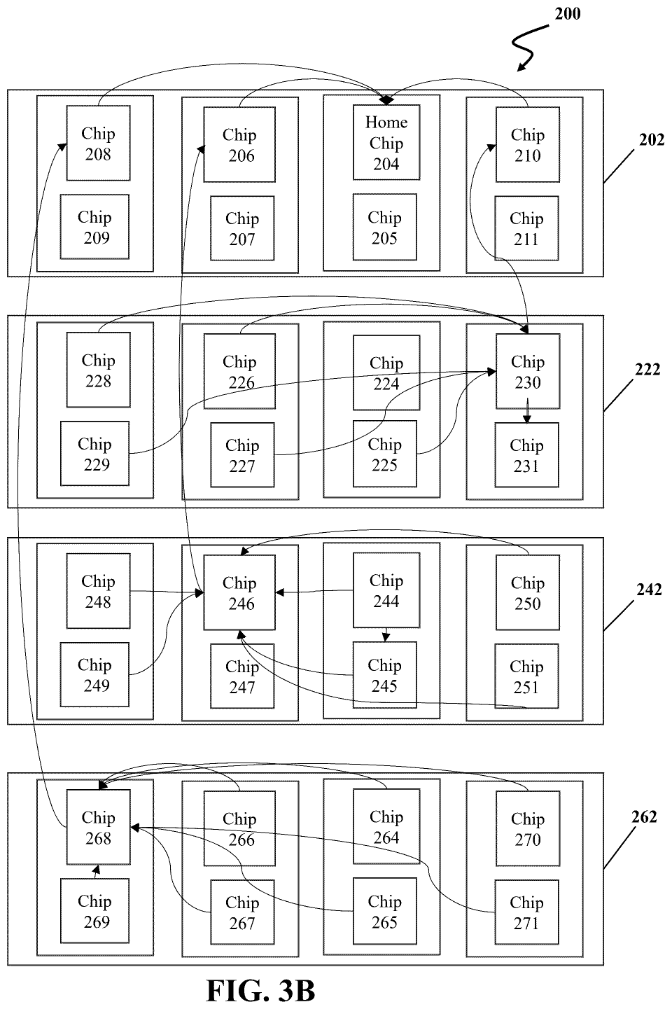

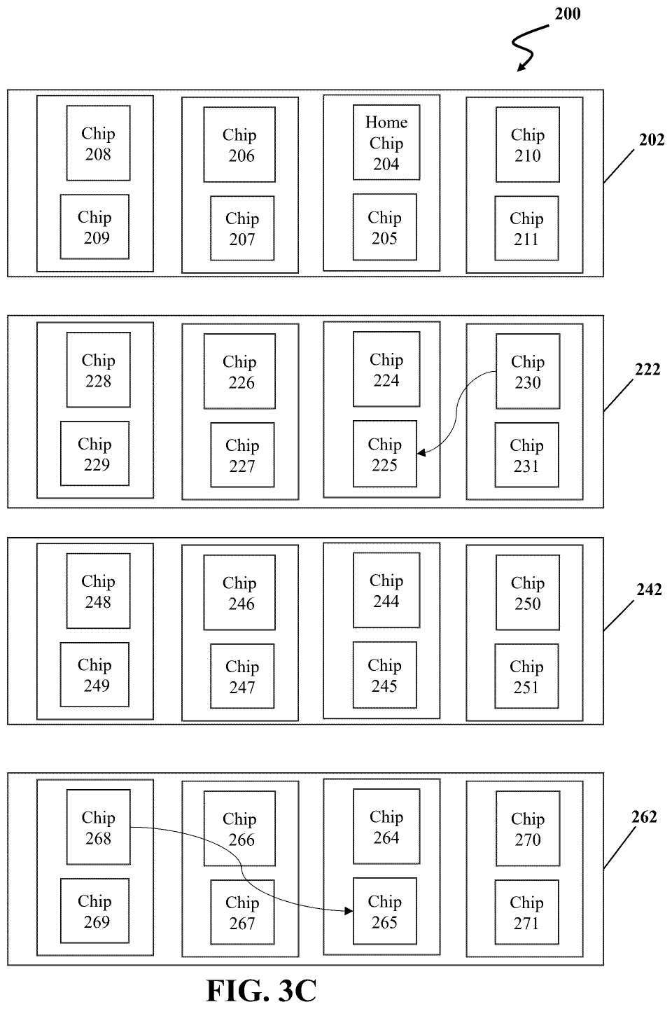

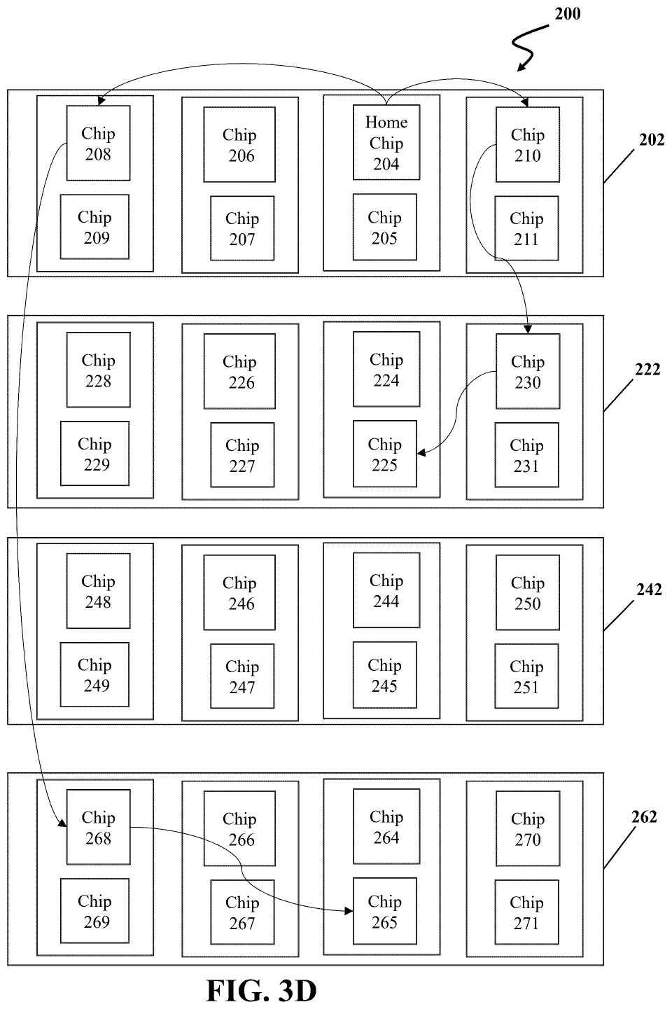

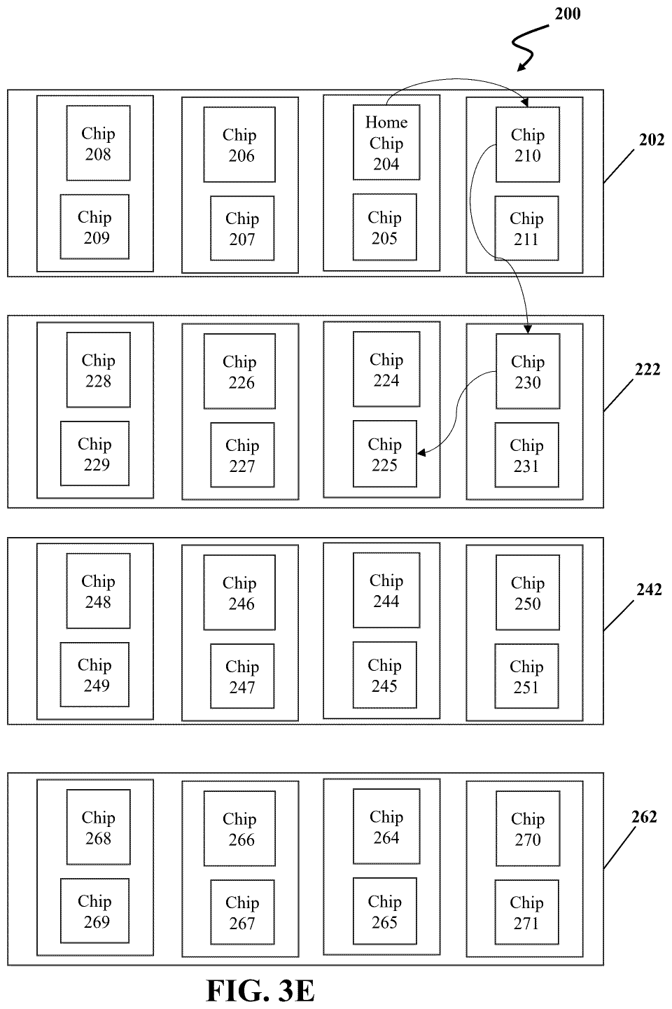

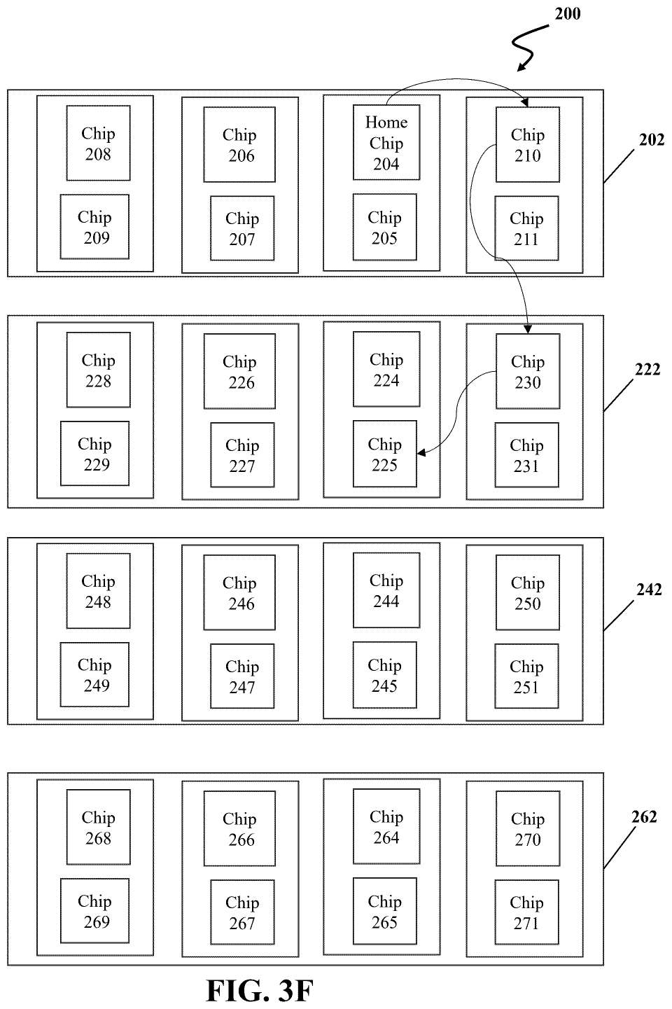

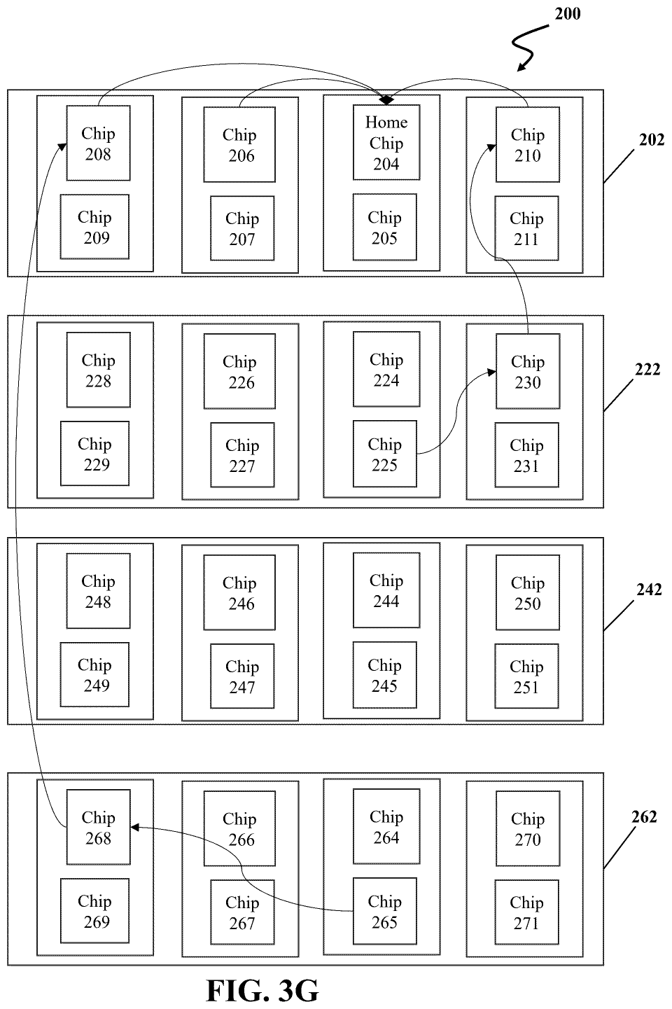

In some embodiments, in FIG. 3A-G if system 200 cannot perform the store in the requesting drawer 202 (a depicted in FIG. 2A-F), the system may have to go to another drawer. In some embodiments, some embodiments, system 200 may include multiple drawers. In some instances, multiple drawers in a distributed system are connected via high-speed interconnects, which enable low-latency communication between processors and memory across drawers. System may use fabric or bus topologies such as crossbar switches or mesh networks to provide scalable, redundant data pathways. Coupling links ensure synchronized operations and coherent memory access between drawers, while I/O and networking links manage connections to external systems through PCIe slots or network interfaces. These connections ensure efficient data exchange, resource sharing, and system-wide coordination.

FIG. 3A-H depicts multiple drawers, for example drawer 202, drawer 222, and drawer 242, and drawer 262 in distributed system 200. In some embodiments, drawer 222 may include chips 224, 225, 226, 227, 228, 229, 230, and 231. In some embodiments, drawer 242 may include chips 244, 245, 246, 247, 248, 249, 250, and 251. In some embodiments, drawer 262 may include chips 264, 265, 266, 267, 268, 269, 270, and 271.

FIG. 3A depicts broadcasting a signal for each drawer to look for the line. In a distributed system, a different chip in requesting drawer 202 may broadcast to each of the other drawers. In some embodiments, a different chip from drawer 202 may broadcast to the other drawers in system 200. For example, chip 210 may broadcast to drawer 222, chip 206 may broadcast to drawer 242, and chip 208 may broadcast to drawer 262. In some embodiments, chip that receives the broadcast signal for each drawer may examine the respective drawer caches to determine where the line may be in the memory for that drawer. In some embodiments, each drawer may have a controlling chip that forwards the broadcast to the other chips in the drawer, for example chips 230, 246 and 268. In an example, the highest coherency copy of the line is found in drawer 222 where data for the pending operation may be stored in drawer 222.

Referring to FIG. 3B, a partial response may be sent from every chip back to the requesting chip through the controlling chip. For example, the partial response may for every chip in a drawer may be sent to the controlling chip for the drawer, e.g., chips 230, 246 and 268, where the controlling chip can generate a drawer scope combined response for each drawer. Based on the drawer scope combined response the control chip for each drawer, e.g., chips 230, 246 and 68, may send a partial response representing the drawer state to requesting chip 204. For example, the partial response for every chip in a drawer may be sent to the controlling chip for the drawer, e.g., chips 230, 246 and 268, and a combined partial response (e.g., global partial response). for each drawer may be sent to requesting chip 204 through chips 208, 206, and 210. In the FIG. 2A-F, the combined partial response represents one drawer only so still is considered partial from system coherency perspective. In some instances, the controlling chip for each drawer generates the drawer combined response, which is the view of the drawer. For example, chip 230 assembles responses from chips within drawer 222, chip 246 assembles responses from chips within drawer 242, chip 268 assembles responses from chips within drawer 262. Continuing the example, chips 230, 246, and 268 may then send their accumulated responses (e.g., Combined Partial Response or Global Partial Response) to requesting chip 204 in drawer 202 through the respective intermediate chips 210, 206, and 208 in drawer 202.

FIG. 3C depicts sending the drawer scope combined response to participating chips (e.g., chip 225 and chip 265). In some embodiments, the system 200 may send the combined response only to chips participating in the line, and chips that are not participating, i.e., do not have an address contention and are not a coherency point for the operation, may return a partial response and any credits for the operation. In some embodiments, the system 200 may exclude the non-participating chips from further communication for the operation. In some embodiments, the partial response may indicate a compare in a chip. In some instances, a compare indicates another operation in the same line. In some embodiments, when a compare is detected in a chip that chip may be included in the communication loop.

Referring to FIG. 3D, all participating chips may receive a global combined response from the requesting chip. In some embodiments, the global combined response is sent from requesting chip 204 through intermediate chips 208, and 210 in the requesting drawer and through chips 268, and 230 in drawers 222, and 262 to participating chips 265, and 265 in drawers 222; and 262. In some embodiments, where there is an address contention, the system 200 may need to consider multiple chips in multiple drawers. In some embodiments, all participating chips may include the requesting chip, any chips possibly participating in the operation, and any chips that link the requesting chip to any chips possibly participating. In some embodiments, the global combined response includes instructions on where the data for the operation may be stored.

FIG. 3E depicts how the data for the operation may be routed. In this example, the global combined response indicates that the data is to be stored on chip 225. The requesting chip 204 may send the data through chip 210 to drawer 222. The receiving chip 230 receives the data and routs it to the storing chip 225 (i.e., an intervention master chip where the store is to be performed).

FIG. 3F depicts the end of coherency response (ERESP) flow once it is safe to perform the store. In some embodiments, ERESP indicates End of Coherency Response and informs intervention master chip that all address contentions if any has been resolved. In some instances, ERESP also caries information on whether it is safe to complete to Store or the Store needs to be canceled due to pervious ordered store failure to acquire resource or coherency. In this example, the store flows from requesting chip 204 through chip 210 to chip 230 and finally to storing chip 225. In this example, the requesting chip 204 may forward record of the ERESP to inform the owner of the line (e.g., intervention master chip 225) that is safe to perform this the actual store. Upon receipt of the end of coherency response ERESP, the store may be performed. In some embodiments, the ERESP may indicated that the store needs to be canceled due to pervious ordered store failure to acquire resource or coherency.

FIG. 3G depicts the distribution of the Reset/sponse/Final Response (RRESP/FRESP). In some embodiments, other participating chips in the system 200 may a call reset response or final response to indicate each chip is done with the operation. For example, example participating chip 265, chip 245, and or chip 225 may send an end of coherency response to requesting chip 204. In some embodiments, RRESP represents Reset response which indicates that all address contentions if any has been resolved and the controller is ready to reset, and FRESP represent Final Response with includes Reset Response along of Coherency response indicating that all read-only copies of the line in the caches has been invalidated.

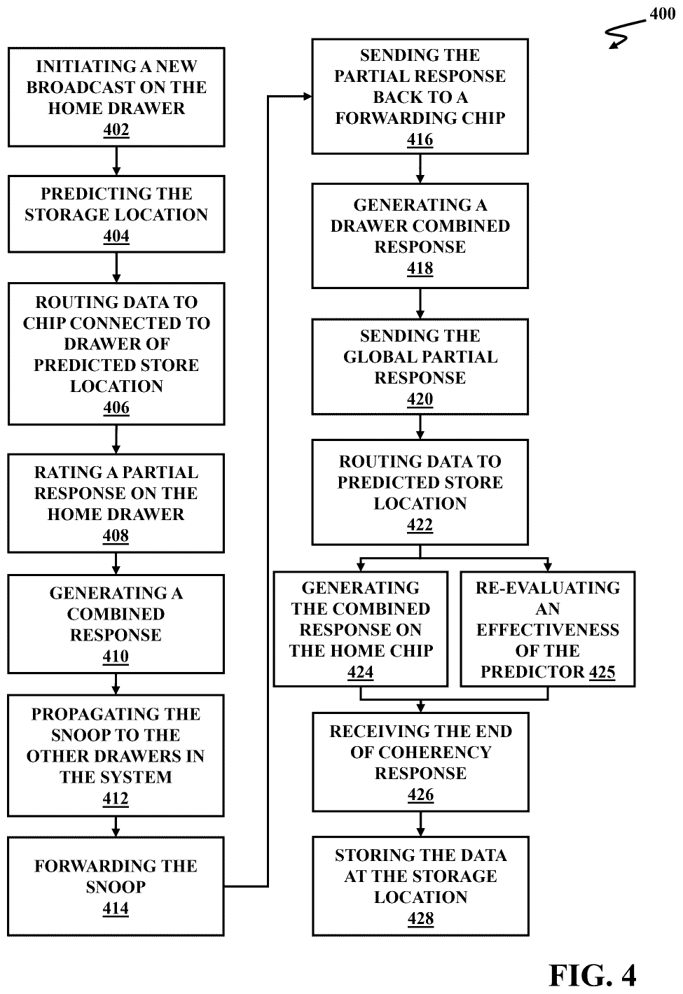

FIG. 4 depicts an illustrative method 400 for prediction location of lines in a distributed system. Operations of method 400 may be enacted by one or more computing environments, such as the system 100, such as the system 200, or the like.

Method 400 begins with operation 402 of initiating a snoop (e.g., a new broadcast) on the requesting drawer. In some embodiments, a snoop broadcast may be a broadcast technique used in cache coherence protocols, especially in multiprocessor systems, to maintain data consistency across caches. When one processor writes to a shared memory location, other processors need to be notified to ensure that they are not holding stale copies of that data in their caches. In some embodiments, messages sent within the same drawer may be sent through an X-bus or an M-bus.

Method 400 continues with operation 404 of predicting the storage location for the data in the stream using the combined response. In some embodiments, a predictive algorithm is used to predict a line location of preceding stores in a stream.

In some embodiments, the success rate of the data routing through the predicted line location is monitored. In some embodiments, the algorithm may be updated to improve the accuracy of the prediction based on the success rate. In some embodiments, responsive to the prediction of the line location no longer being accurate, the system may adjust the prediction of the line location and behavior of the data routing.

Method 400 continues with operation 406 of sending the data to the predicted storage location.

Method 400 continues with operation 408 of generating a partial response on the requesting drawer and sending the partial response to the requesting chip.

Method 400 continues with operation 410 of generating a combined response at the requesting chip in the requesting drawer and sending the combined response to the other chips in the requesting drawer.

Method 400 continues with operation 412 of propagating the snoop to the other drawers in the system. In some embodiments, the snoop may propagate across an A-bus. For example, A-busses may be between drawers.

Method 400 continues with operation 414 of forwarding the snoop to the rest of the chips within the remote drawers. In some embodiments, the chips in the system may generate a partial response based on the snoop.

Method 400 continues with operation 416 of sending the partial response back to a forwarding chip in each drawer.

Method 400 continues with operation 418 of generating, by the forwarding chip, a drawer combined response. In embodiments, operation 418 may also include forwarding the combined partial response on the A bus to the requesting drawer. In some embodiments, operation 418 validates the prediction and the data may be stored at the predicted storage location.

Method 400 continues with operation 420 of sending the global partial response from each drawer to the requesting chip across the x-bus/M-bus.

Method 400 continues with operation 422 of preemptively routing data to the predicted store location. In some embodiments, preemptively routing is performed before the storage location has been verified as described herein.

Method 400 continues with operation 424 of generating the combined response on the requesting chip. In some instances, at this point a traditional system that does not predict the storage location may start sending data because the system has identified where that data is slated to go. In some embodiments, if the storage location that was predicted is not the correct storage location, the data may be rerouted to the correct storage location.

Method 400 continues with operation 425 (may be run in parallel to operation 424) of re-evaluating an effectiveness of the predictor and making adjustments to the predictor, if necessary.

Method 400 continues with operation 426 of receiving, at the requesting chip, the end of coherency response from all chips active in the operation.

Method 400 continues with operation 428 of storing the data at the storage location.

In some embodiments, an illustrating how a Store Stream identification (ID) can be assigned to the store based on Requesting Unit, Requester ID, IO Channel ID, Card ID or Partition ID. In some instances, memory location is also used to assign a stream ID. In some embodiments, the system may not assign the same stream ID to addresses targeting different memory locations. Once the stream ID is assigned then based on the store address can be determined where is the memory location and use that as initial prediction for the store location. In some embodiments, once the system, determines the store location for complete stores the prediction can be switched to point to the new location. If the prediction has been unsuccessful for the past five stores and the new store location is consistent across the five stores, the system may update the predicted store location to the new store location. In some embodiments, if the prediction continues to be unsuccessful after switching to the new location, the system may disable the prediction use for the store stream. In some embodiments, if the prediction is disabled and the system identifies 5 consecutive stores from that stream that target that are performed in the same chip or drawer the system may update the predicted data location and re-enable the predictor use. In some embodiments, a system or user may change data location vector to monitor any number of stores above 2. For example, instead of 5 consecutive stores, the system may monitor 3 consecutive stores to determine if the prediction is accurate.

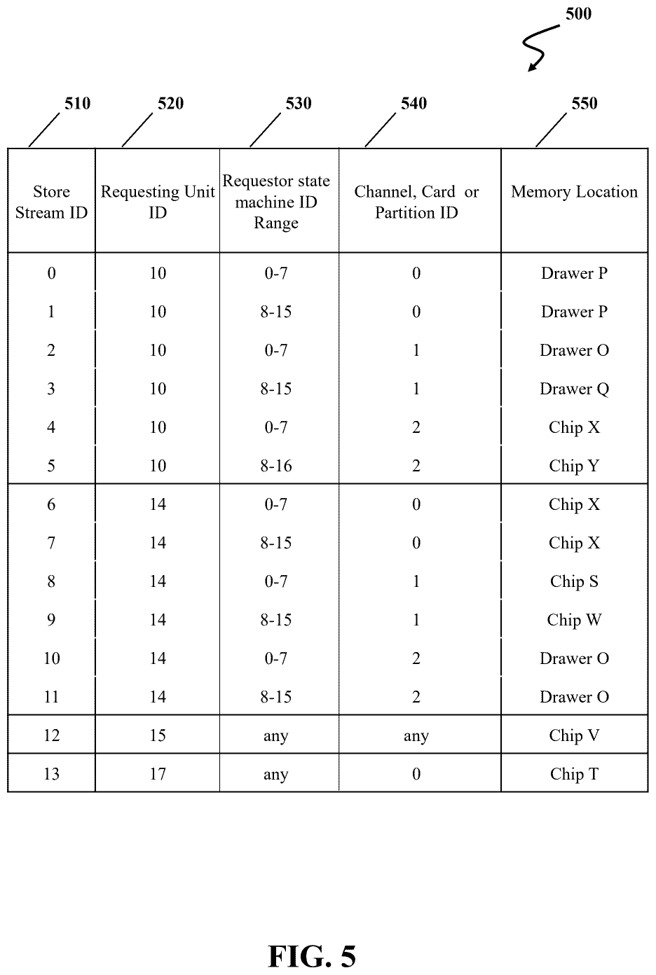

FIG. 5 depicts a table 500 of data that is used to determine store stream ID. In some embodiments, table 500 columns include store stream ID 510, requesting unit ID 520 requestor state machine ID range 530, channel, card, or partition ID 540, and memory location 550. All numbers, identifications and location names in the figures are for explanatory purposes and not meant to be limiting.

In some embodiments, requesting unit ID column 520 is the identifier for the requesting unit. In some instances, each chip in each drawer may have multiple units. In some embodiments, the system may use the unit ID to associate any request coming from that unit with a subset of store stream IDs. For example, in column 520 unit ID 10 is associated with store stream IDs 0-5 in column 510.

In some embodiments, within each unit (identified in column 520), there are store state machines (identified in column 530) that may be used to perform those stores and depending on Certain configurations of each unit. In this illustration, each unit may have multiple state machines (e.g., 15, 7, etc.) with different state machines being designated for different store streams (identified in column 510). For example, half of the store state machines to be used by a first channel and the other half of use by a second channel where different ranges may be used for different type of stores. For instance, there may be cases where the system may use the requester state machine ID range to designate a store stream ID in column 510. In some embodiments, for different memories different stream IDs may be used, so the system may use the memory location as part of the determination of where to send data. For example, where requesting unit 10 has 16 state machines, the system may designate store stream 0 for partition 0 using the 0-7 state machines. For example, where requesting unit 10 has 15 state machines, the system may designate store stream 3 for partition 1 using the 8-15 state machines.

For each store stream ID, there may be a main memory location, e.g., memory location column 550. The main memory location may be determined by a lookup table containing the main memory location for each store stream ID. In some embodiments, the prediction model my default to memory location, shown in column 550, for each store stream ID in column 510.

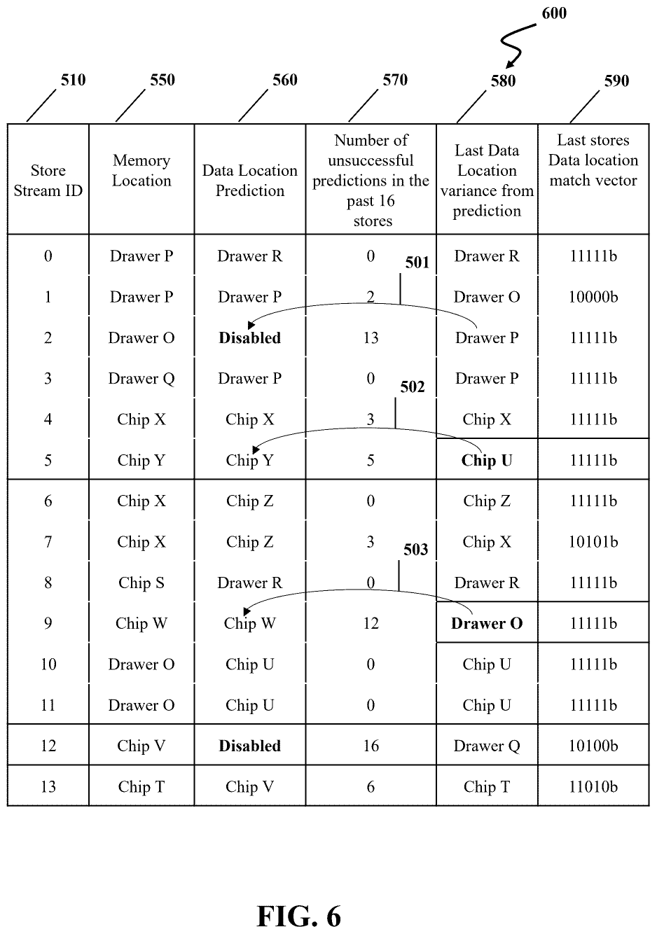

FIG. 6 depicts table 600 of data used in the process of predicting a storage location. In some embodiments, table 600 columns include store stream ID 510 (also depicted in FIG. 5), memory location 550 (also depicted in FIG. 5), data location prediction 560, number of unsuccessful predictions in the past 16 stores 570, last data location variance from prediction 580, and last stores data location match vector 590. The number of unsuccessful predictions in the past 16 stores 570 lists how many of the last 16 stores have been wrong. In some instances, 16 is an example, the system may pick any number of stores. In some instances, data location prediction 560 is the current prediction for store stream ID in column 510. In some instances, last data location variance from prediction 580 is the actual last storage location where the prediction was wrong in the last 16 stores, again 16 is an example and the system or a user may pick this number. In some embodiments, where there has not been an incorrect prediction in the last 16 stores, the system may default to the data location prediction 560. For example, store stream ID 0 has Drawer R for both the data location prediction 560 and the last data location variance from prediction 580.

In the depicted example, the last stores data location match vector 590 lists the outcome of the last 5 stores matching the last data location variance from prediction 580, 5 is an example number and the system or a user may pick this number, where 1 was a correct prediction and 0 was a wrong prediction. Where the last 5 stores have matched a different location (e.g., where last data location variance from prediction 580 does not match the data location prediction 560) from the data location prediction 560, the data location prediction 560 may be changed to the value listed in the last data location variance from prediction 580. For example, arrows 501, 502, and 503 indicate situation where the data location prediction 560 would be updated.

In some embodiments, the system may disable the prediction in a situation where there have been a threshold number of incorrect predictions in the past 16 stores. For example, store stream 12 has been disabled because the prediction has been incorrect 16 out of the last 16 times. In the example depicted in FIGS. 6, 13 may be the threshold for the system to disable the prediction noting that streams 12 and 2 are currently disabled. In the depicted example, the prediction for stream 2 is currently disabled, but is to be reenabled (shown by arrow 501) updated to drawer P since drawer P for the last 5 stores.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

1. A system comprising:
a memory storing program instructions; and
a processor in communication with the memory, the processor being configured to execute the program instructions to perform processes comprising:
executing an predictive algorithm for a distributed system, wherein the predictive algorithm comprises a predictor using line location of preceding stores in a first stream and routing data preemptively towards the line location;
identifying, through a mechanism, a stream of stores targeting an identified chip in the distributed system; and
applying the predictive algorithm in the system.

2. The system of claim 1, wherein the memory stores further program instructions, and wherein the processor is configured to execute the further program instructions to perform the processes further comprising:
predicting, by the predictor, to the line location;
utilizing the predictor to route data to a first chip towards the predicted line location; and
forwarding the data to a second chip once a resource becomes available.

3. The system of claim 2, wherein the memory stores further program instructions, and wherein the processor is configured to execute the further program instructions to perform the processes further comprising:
monitoring a success rate of data routing through the predicted line location; and
responsive to the prediction of the line location no longer being accurate, adjusting the prediction of the line location and behavior of the data routing.

4. The system of claim 1, wherein the memory stores further program instructions, and wherein the processor is configured to execute the further program instructions to perform the processes further comprising:
initiating a new broadcast on a requesting drawer for a line;
generating a partial response on the requesting drawer and sending the partial response to a requesting chip in the requesting drawer;
generating a combined response at the requesting chip in the requesting drawer and sending the combined response to other chips in the requesting drawer; and
sending the data to a predicted storage location.

5. The system of claim 1, wherein the memory stores further program instructions, and wherein the processor is configured to execute the further program instructions to perform the processes further comprising:
switching a predicted data location to a different memory location based on a number of unsuccessful stores.

6. The system of claim 1, wherein the memory stores further program instructions, and wherein the processor is configured to execute the further program instructions to perform the processes further comprising:
validating a prediction generated by the predictive algorithm; and
storing, based on a successful prediction, data in a predicted location identified by the prediction.

7. The system of claim 5, wherein the memory stores further program instructions, and wherein the processor is configured to execute the further program instructions to perform the processes further comprising:
receiving, by a chip performing the store, an end of coherency response indicating that it is safe to perform a store.

8. A method comprising:
executing an predictive algorithm for a distributed system, wherein the predictive algorithm comprises a predictor using line location of preceding stores in a first stream and routing data preemptively towards the line location;
identifying, through a mechanism, a stream of stores targeting an identified chip in the distributed system; and
applying the predictive algorithm in the system.

9. The method of claim 8, further comprising:
predicting, by the predictor, to the line location;
utilizing the predictor to route data to a first chip towards the predicted line location; and
forwarding the data to a second chip once a resource becomes available.

10. The method of claim 9, further comprising:
monitoring a success rate of data routing through the predicted line location; and
responsive to the prediction of the line location no longer being accurate, adjusting the prediction of the line location and behavior of the data routing.

11. The method of claim 8, further comprising:
initiating a new broadcast on a requesting drawer for the-a line;
generating a partial response on the requesting drawer and sending the partial response to a requesting chip in the requesting drawer;
generating a combined response at the requesting chip in the requesting drawer and sending the combined response to other chips in the requesting drawer; and
sending the data to a predicted storage location.

12. The method of claim 8, further comprising:
switching a predicted data location to a different memory location based on a number of unsuccessful stores.

13. The method of claim 8, further comprising:
validating a prediction generated by the predictive algorithm; and
storing, based on a successful prediction, data in a predicted location identified by the prediction.

14. The method of claim 13, further comprising:
receiving, by a chip performing the store, an end of coherency response indicating that it is safe to perform a store.

15. A computer program product comprising one or more computer readable storage media having program instructions collectively embodied therewith, the program instructions executable by one or more processors to cause the one or more processors to perform a method, the method comprising:
executing an predictive algorithm for a distributed system, wherein the predictive algorithm comprises a predictor using line location of preceding stores in a first stream and routing data preemptively towards the line location;
identifying, through a mechanism, a stream of stores targeting an identified chip in the distributed system; and
applying the predictive algorithm in the system.

16. The computer program product of claim 15, further comprising additional program instructions collectively stored on the one or more computer readable storage media and configured to cause the one or more processors to perform the method further comprising:
predicting, by the predictor, to the line location;
utilizing the predictor to route data to a first chip towards the predicted line location; and
forwarding the data to a second chip once a resource becomes available.

17. The computer program product of claim 16, further comprising additional program instructions collectively stored on the one or more computer readable storage media and configured to cause the one or more processors to perform the method further comprising:
monitoring a success rate of data routing through the predicted line location; and
responsive to the prediction of the line location no longer being accurate, adjusting the prediction of the line location and behavior of the data routing.

18. The computer program product of claim 15, further comprising additional program instructions collectively stored on the one or more computer readable storage media and configured to cause the one or more processors to perform the method further comprising:
initiating a new broadcast on a requesting drawer for a line;
generating a partial response on the requesting drawer and sending the partial response to a requesting chip in the requesting drawer;
generating a combined response at the requesting chip in the requesting drawer and sending the combined response to other chips in the requesting drawer; and
sending the data to a predicted storage location.

19. The computer program product of claim 15, further comprising additional program instructions collectively stored on the one or more computer readable storage media and configured to cause the one or more processors to perform the method further comprising:
switching a predicted data location to a different memory location based on a number of unsuccessful stores.

20. The computer program product of claim 15, further comprising additional program instructions collectively stored on the one or more computer readable storage media and configured to cause the one or more processors to perform the method further comprising:
validating a prediction generated by the predictive algorithm;
storing, based on a successful prediction, data in a predicted location identified by the prediction; and
receiving, by a chip performing the store, an end of coherency response indicating that it is safe to perform a store.
